(19) United States
(12) Patent Application Publication
(10) Pub. No.: US 2026/0321791 A1
(43) Pub. Date: Oct. 15, 2026

(54) Battery Immersion Cooling Apparatus

(71) Applicants: SK On Co., Ltd., Seould (KR); SK Innovation Co., Ltd., Seoul (KR)

(72) Inventors: June Ho CHO, Daejeon (KR); Se Hyeon KIM, Daejeon (KR); Tae Hyeon KIM, Daejeon (KR); Sun Hyuk BAE, Daejeon (KR); Jun Young LEE, Daejeon (KR)

(21) Appl. No.: 19/640,617

(22) Filed: Apr. 7, 2026

(30) Foreign Application Priority Data
Apr. 9, 2025 (KR) 10-2025-0046326
Sep. 8, 2025 (KR) 10-2025-0127697

(51) Int. Cl. H01M 10/6568; H01M 10/613; H01M 10/625; H01M 10/6551; H01M 50/249; H01M 50/30; H01M 50/383; B60L 50/64; B60L 58/26

(52) U.S. Cl. CPC H01M 10/6568; H01M 10/613; H01M 10/625; H01M 10/6551; H01M 50/249; H01M 50/383; H01M 50/394; B60L 50/64; B60L 58/26; H01M 2220/20

(57) ABSTRACT

A battery immersion cooling apparatus includes a case configured to accommodate an immersion fluid and a battery cell or a battery module immersed in the immersion fluid, a cooling layer arranged at, at least one surface of the case and one or more thermal transfer elements positioned on one side of the cooling layer and configured to exchange heat with the immersion fluid.

### CROSS REFERENCE TO RELATED APPLICATIONS

This application claims priority to Korean Patent Application No. 10-2025-0046326 filed on Apr. 9, 2025, Korean Patent Application No. 10-2025-0127697 filed on Sep. 8, 2025, Korean Patent Application No. 10-2025-0127725 filed on Sep. 8, 2025, and Korean Patent Application No. 10-2025-0141524 filed on Sep. 29, 2025, the disclosures of which are hereby incorporated by reference in their entireties.

### BACKGROUND

### Technical Field

The present disclosure relates to a battery cooling apparatus, and more particularly, to a battery immersion cooling apparatus for cooling a battery cell or a battery module using an immersion method.

### Technical Considerations

There is a demand for thermal management of lithium-ion battery packs used in Energy Storage Systems (ESS), electric vehicles, and the like.

Lithium-ion batteries may experience thermal runaway due to internal short circuits of cells, overcharging, or external impacts. This may cause a chain reaction of thermal propagation to adjacent cells, potentially leading to fire or explosion of the entire system.

Conventional air-cooling or water-cooling methods have limitations in cooling efficiency because the direct contact area with the cell surface is limited. In particular, it is difficult for these methods to respond promptly to rapid temperature rises, such as those occurring during thermal runaway reactions.

### SUMMARY

Embodiments of the present disclosure may provide a battery immersion cooling apparatus capable of preventing overheating of a battery cell or a battery module and preventing the spread of thermal runaway by exchanging heat with an immersion fluid through thermal transfer elements and a cooling layer.

According to an embodiment of the present disclosure, there is provided a battery immersion cooling apparatus comprising: a case configured to accommodate an immersion fluid and a battery cell or a battery module immersed in the immersion fluid; a cooling layer arranged at at least one surface of the case; and one or more thermal transfer elements formed on one side of the cooling layer and configured to exchange heat with the immersion fluid.

In some non-limiting embodiments, the cooling layer may be disposed separately from the case, and the thermal transfer elements may be immersed in the immersion fluid to provide a liquid headspace zone. Alternatively, the cooling layer may be disposed inside the case, the thermal transfer elements may be immersed in the immersion fluid, and a zone may be formed between the cooling layer and an inner wall of the case to provide a gas headspace zone and a liquid headspace zone.

In some non-limiting embodiments, the thermal transfer elements may be partially immersed in the immersion fluid, wherein a lower portion of the thermal transfer element is positioned in a liquid headspace zone, and an upper portion of the thermal transfer element is positioned in a gas headspace zone.

In some non-limiting embodiments, the gas headspace zone may be in fluid communication with a gas discharge unit disposed on one side of the case and configured to discharge gas generated with in the case.

In some non-limiting embodiments, the cooling layer may include a cooling channel through which a coolant flows, a coolant supply port and a coolant recovery port. The cooling channel may be configured such that coolant therein flows in a direction parallel to a width-length plane dimension of the battery.

In some non-limiting embodiments, the coolant supply port and the coolant recovery port may be disposed parallel to each other in a width dimension of the cooling layer or a length dimension of the cooling layer. Alternatively, the coolant supply port may be disposed in a height dimension of the cooling layer, and the coolant recovery port may be disposed in a width dimension or a length dimension of the cooling layer, such that the flow direction of the coolant flowing through each is perpendicular to each other.

In some non-limiting embodiments, the apparatus further comprising a plurality of coolant supply port, e.g., from the top of the cooling layer distributed along a width or length dimension of the cooling layer.

In some non-limiting embodiments, the cooling layer may include a coolant supply port disposed at an upper portion of the cooling layer, and an impingement jet array disposed below the coolant supply port and configured to spray coolant at a high velocity toward the thermal transfer element. The cooling layer may further include a coolant recovery port disposed below the impingement nozzles and configured to collect the sprayed coolant.

In some non-limiting embodiments, the impingement jet array may comprise a coolant supply manifold connected to the coolant supply port, and a plurality of impingement nozzles connected to the coolant supply manifold and arranged in a width dimension of the cooling layer. In some non-limiting embodiments, the impingement jet array may comprise a coolant supply manifold connected to the coolant supply port and disposed at a center of the cooling layer in a length dimension, and a plurality of impingement nozzles connected to the coolant supply manifold and branching to both sides from the coolant supply manifold.

In some non-limiting embodiments, the cooling layer may be formed of a plurality of module units, and may provide thermal transfer elements having different shapes or different arrangements for each module.

In some non-limiting embodiments, the thermal transfer element may have a shape of at least one of a fin, a rib, a wave, a mesh, a honeycomb, or a needle, and may have a surface roughness (Ra) in a range of about 0.1μm to about 15μm.

In some non-limiting embodiments, an outer surface of the case may have heat sink fins, or the apparatus may further comprise a thermal jacket disposed on an outer periphery of the case.

In some non-limiting embodiments, by immersing a battery cell or a battery module in an immersion fluid and enabling heat exchange with an upper portion of the cell through a cooling layer, overheating of the battery cell or the battery module may be prevented, and propagation of thermal runaway may be prevented.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic view of one embodiment of a cooling layer configuration where the coolant supply port and coolant recovery port are disposed in parallel, with inwardly-projecting thermal transfer elements. In this configuration, thermal transfer elements extend upward from the bottom of the cooling layer.

FIG. 2 illustrates an embodiment of a parallel arrangement, similar to that of FIG. 1, of the coolant supply port and the coolant recovery port, but features outwardly-projecting thermal transfer elements. Here, the thermal transfer elements extend outward from the cooling layer into the immersion fluid.

FIG. 3 depicts an embodiment of a perpendicular arrangement of a cooling layer configuration, where multiple coolant supply ports are disposed in the height dimension of the cooling layer while the coolant recovery port is disposed in a width or length dimension, creating perpendicular positioning. This embodiment also uses convex-type thermal transfer elements.

FIG. 4A is a schematic front view illustrating an embodiment of a detachable cooling assembly where the cooling layer is positioned separately from the case. Thermal transfer elements are immersed in the immersion fluid, providing only a liquid headspace zone. The coolant supply port and the coolant recovery port are disposed parallel to each other. This configuration facilitates maintenance work during cell replacement.

FIG. 4B is a schematic plan view illustrating an embodiment of the detachable cooling assembly of FIG. 4A, wherein cooling channels are visible.

FIG. 4C is a schematic side view illustrating the detachable cooling assembly of FIGS. 4A and 4B.

FIG. 5 is a schematic view illustrating an embodiment of a partial immersion configuration in which each thermal transfer element is only partially immersed in the immersion fluid. The lower portion of the thermal transfer element is positioned in the liquid headspace zone, while the upper portion is positioned in the gas headspace zone. This dual-environment structure allows heat transfer to occur simultaneously in both liquid and gas phases.

FIG. 6A is a schematic front view illustrating an embodiment of an integrated cooling assembly where the cooling layer is disposed inside the case rather than separately. Thermal transfer elements are immersed in the immersion fluid, and a gas headspace zone is formed between the cooling layer and an inner wall of the case. This configuration provides both a gas headspace and a liquid headspace zone simultaneously. The headspace is in fluid communication with a gas discharge unit to discharge gas generated during thermal runaway reactions.

FIG. 6B is a schematic plan view illustrating the integrated cooling assembly of FIG. 6A, wherein cooling channels are visible.

FIG. 6C is a schematic side view illustrating the integrated cooling assembly of FIGS. 6A and 6B.

FIG. 7A is a schematic front view illustrating an embodiment of a detachable cooling assembly having an impingement jet array. The impingement jet array includes a coolant supply manifold connected to the coolant supply port and multiple impingement nozzles arranged in the width dimension of the cooling layer. The nozzles spray coolant at high speed toward the thermal transfer element to improve heat exchange efficiency.

FIG. 7B is a schematic plan view illustrating the detachable cooling assembly having an impingement jet array of FIG. 7A.

FIG. 7C is a schematic side view illustrating the detachable cooling assembly having an impingement jet array of FIGS. 7A and 7B.

FIG. 8A is a schematic front view illustrating an embodiment of a detachable cooling assembly having an impingement jet array, but differs in the manifold arrangement as compared to earlier Figures. The coolant supply manifold is disposed at the center of the cooling layer in the length dimension, and the impingement nozzles branch to both sides from the manifold. This creates a symmetrical distribution pattern along the width dimension.

FIG. 8B is a schematic plan view of the detachable cooling assembly having an impingement jet array of FIG. 8A.

FIG. 8C is a schematic side view illustrating the detachable cooling assembly having an impingement jet array of FIGS. 8A and 8B.

FIG. 9 is a schematic view illustrating an embodiment where the outer surface of the case is formed with heat sink fins. Multiple fins made of metallic material protrude from the outer surface to increase contact area with air and promote heat dissipation by natural convection.

FIG. 10 is a schematic view illustrating an embodiment with a thermal jacket disposed on the outer periphery of the case. The thermal jacket includes covers and internal flow paths in close contact with the case outer periphery, through which coolant circulates.

### DETAILED DESCRIPTION

Hereinafter, embodiments or aspects will be described in detail with reference to the accompanying drawings. However, since various changes may be made in the embodiments or aspects, the scope of the patent disclosure is not limited or restricted by these embodiments or aspects. It should be understood that all modifications, equivalents, and alternatives for the embodiments or aspects are comprised in the scope of the present disclosure. For example, it is to be understood that the present disclosure may assume various alternative variations and step sequences, except where expressly specified to the contrary. It is also to be understood that the specific devices and processes illustrated in the attached drawings, and described in the following detailed description, are simply exemplary and non-limiting embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “comprise”, “comprises”, “comprising”, “include”, “includes”, “including”, “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

It will be understood that when a component is described as being “connected,” “combined” or “coupled” to another component, the component may be directly connected or coupled to the another component, but it may be “connected,” “combined” or “coupled” to the another component by an intervening another component that may be present.

Further, in describing the components of the embodiment or aspect, the meaning of “or” may mean each of the components, may mean two or more of the components, or may mean all of the components. For example, it should be understood that the expressions “a, b or c” represent any one of “a,” “b,” “c,” “a and b,” “a and c,” “b and c,” and “a, b and c.”

Components comprised in one embodiment or aspect and components comprising common functions will be described using the same names in other embodiments or aspects. The description given in one embodiment or aspect may be applied to other embodiments or aspects, and therefore will not be described in detail within the overlapping range, unless there is a description opposite thereto.

The device and/or ‘data’ processed by the device may be expressed in terms of ‘information”. Here, the information may be used as a concept comprising the data.

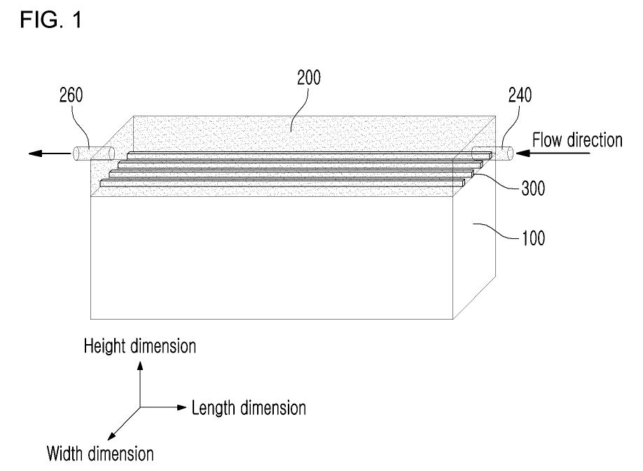

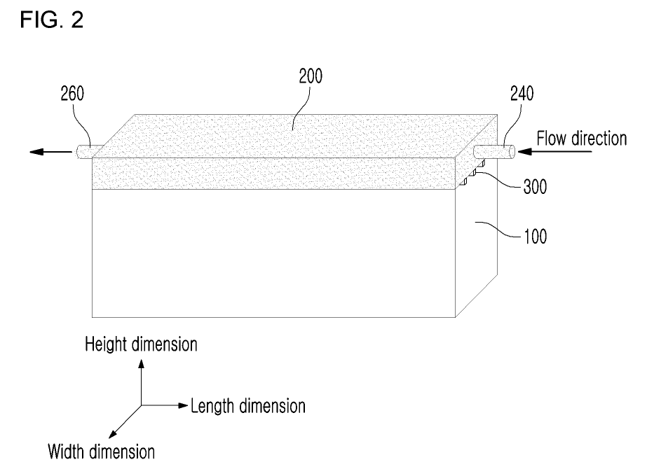

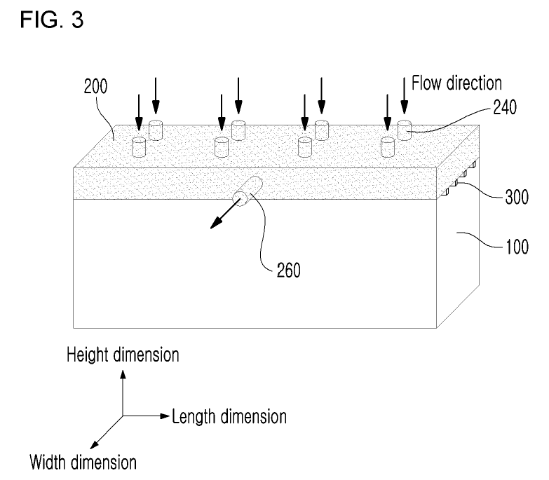

FIGS. 1-3 provide basic cooling layer configurations, wherein the coolant supply port and coolant recovery port are disposed in parallel (FIGS. 1 and 2) or perpendicularly (FIG. 3). FIGS. 1-3 also depict inwardly-projecting thermal transfer elements (FIG. 1) and outwardly-projecting thermal transfer elements (FIGS. 2 and 3).

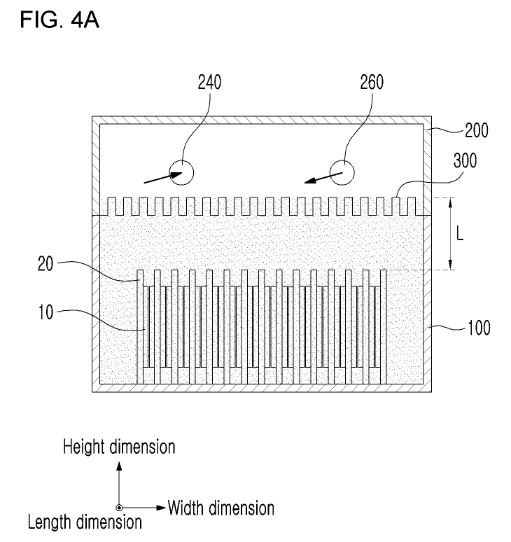

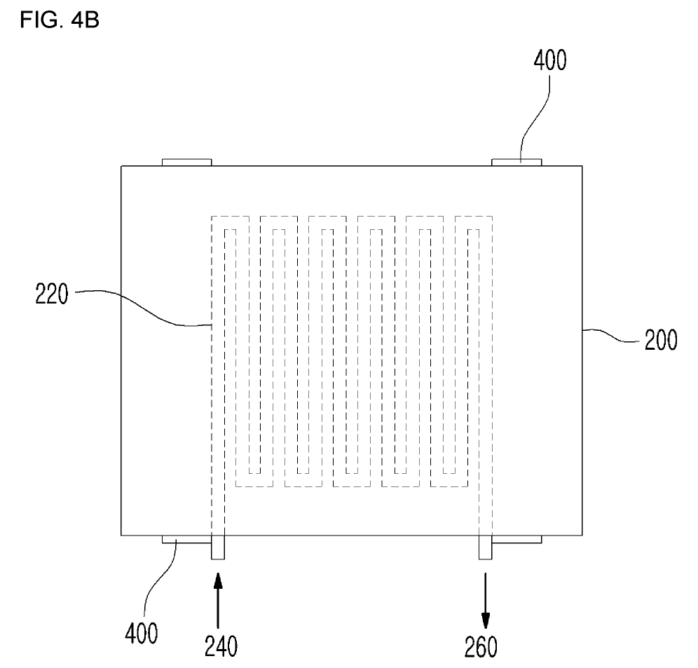

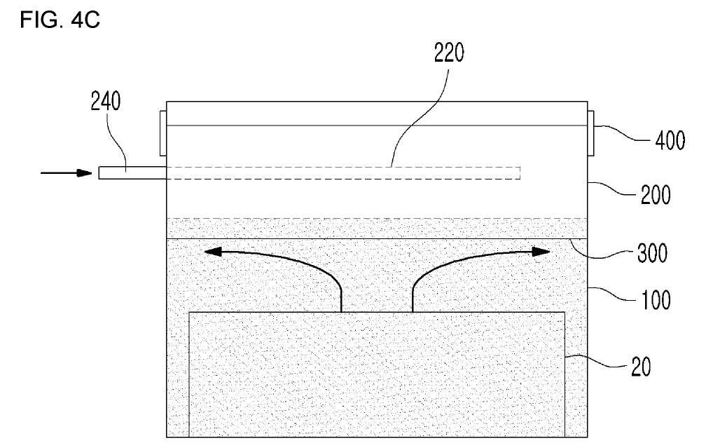

FIGS. 4A–4C, 5, 6A–6C provide exemplary embodiments of various cooling channel configurations that may be utilized according to the present disclosure.

The cooling layer includes internal cooling channels 220 through which coolant flows in a parallel, planar dimension. The cooling channel is formed inside the cooling layer and provides a path through which external coolant is introduced, circulated inside the cooling layer, and then recovered. The coolant supply port 240 and coolant recovery port 260 are connected to the cooling channel at opposite sides of the cooling layer.

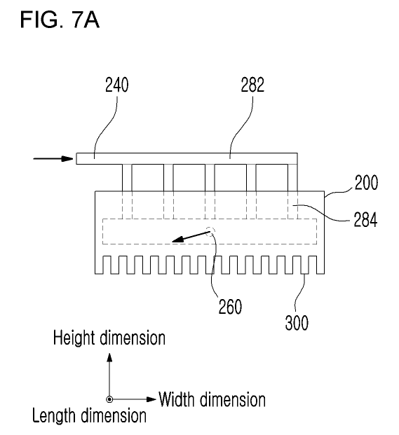

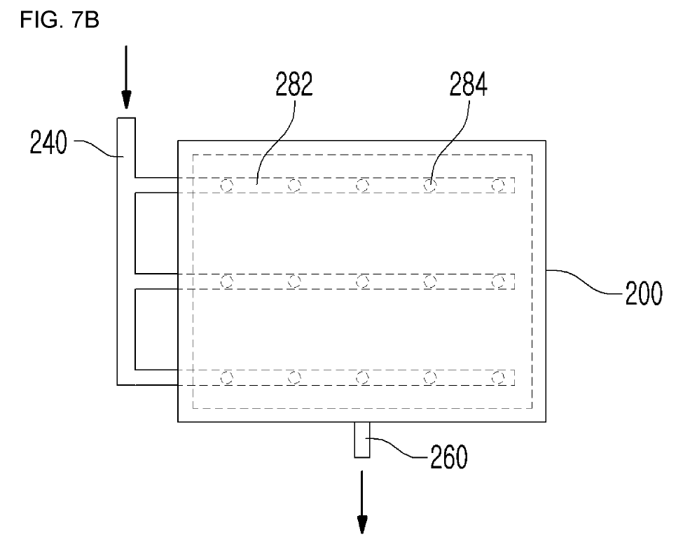

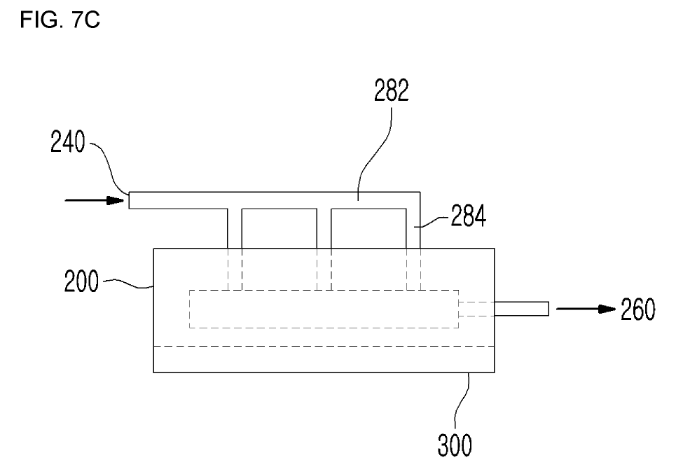

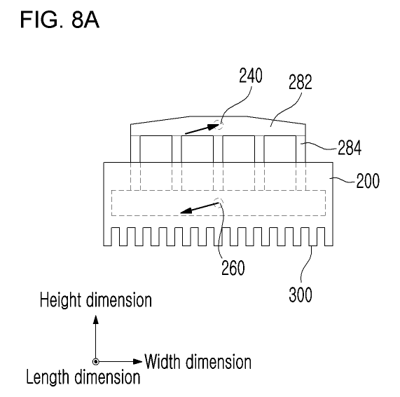

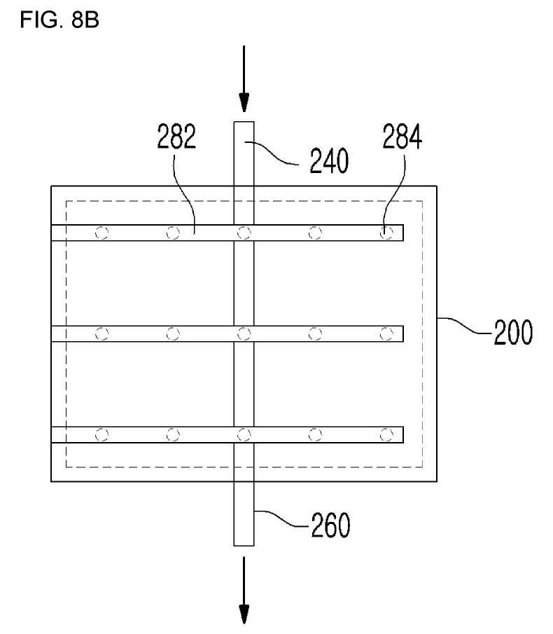

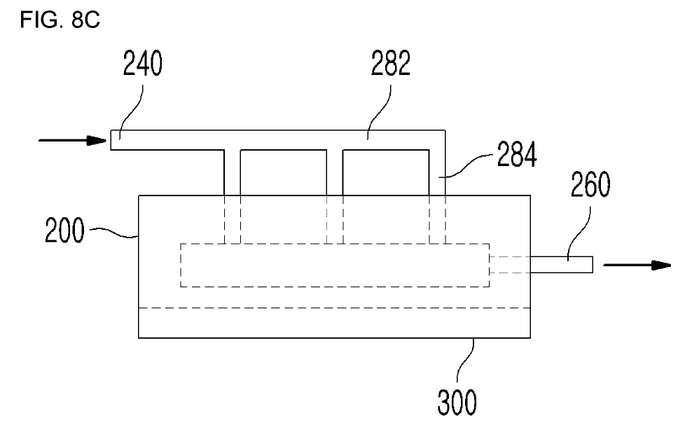

FIGS. 7A–7C, 8A–8C provide exemplary embodiments of various impingement jet array configurations that may be utilized according to the present disclosure. As an alternative, the cooling layer may include a coolant supply port disposed at an upper portion, and an impinging jet array disposed below the coolant supply port to spray coolant toward the thermal transfer elements. This configuration uses a coolant supply port and impingement jet nozzles to spray coolant at high speed, rather than circulating it through internal channels.

As will be described further herein, the various embodiments and configurations disclosed herein prevent overheating and propagation of thermal runaway reactions by enabling heat exchange with the immersion fluid through the thermal transfer element and cooling layer. By immersing the battery in an immersion fluid and enabling heat exchange at the upper portion of the cell through the cooling layer, the apparatus can effectively suppress dangerous thermal events.

The various embodiments disclosed herein display superior cooling efficiency over conventional air-cooling or water-cooling methods limitations by providing direct, comprehensive contact between the cooling medium and the battery components. The thermal transfer elements are strategically disposed on the upper layer flow protruding into a space where heated immersion fluid tends to stay, allowing for quick and intentional removal of residual heat from the upper layer fluid. Various protrusion shapes (fin, rib, wave, mesh, honeycomb, needle) can be selectively applied to implement an optimal heat transfer structure according to the cell position, heat generation characteristics, or flow direction of the immersion fluid. Because the direct contact area with the cell surface is expanded, cooling elements can respond promptly to rapid temperature rises such as those occurring during thermal runaway reactions.

As shown in the FIGS (e.g., FIG. 1), a battery immersion cooling apparatus according to an embodiment of the present disclosure includes a case 100 configured to accommodate an immersion fluid 50 and a battery cell 10 or a battery module 20 immersed in the immersion fluid 50, a cooling layer 200 on at least one surface of the case 100 and one or more thermal transfer elements 300 formed on one side of the cooling layer 200 and configured to exchange heat with the immersion fluid 50. In certain embodiments, the cooling layer includes a cooling channel through which a coolant flows. In certain embodiments, the battery is fully immersed in the immersion fluid 50. In certain embodiments, the thermal transfer elements are positioned in a liquid headspace zone where heated immersion fluid 50 rises by natural convection. The immersion fluid, as will be recognized by one of skill in the art, may be a dielectric fluid having a dielectric breakdown strength sufficient to electrically isolate the battery cell or battery module.

The case 100 according to an embodiment of the present disclosure may be formed as an open-top structure or as a sealed structure so as to accommodate the immersion fluid 50 therein. The case 100 is structured such that the battery cell 10 or the battery module 20 may be completely immersed in the immersion fluid 50. Typically, cases have a rectangular or cylindrical structure. The case 100 may be formed of any suitable material, such as metallic material or an insulating polymer composite material, which will be described in further detail below. The cooling layer 200 may be installed such that the heat transfer elements face on an internal surface of the case. Multiple cooling layers may be installed, if desired.

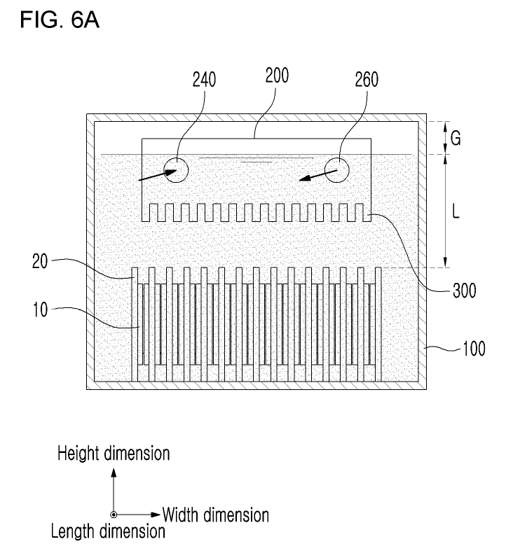

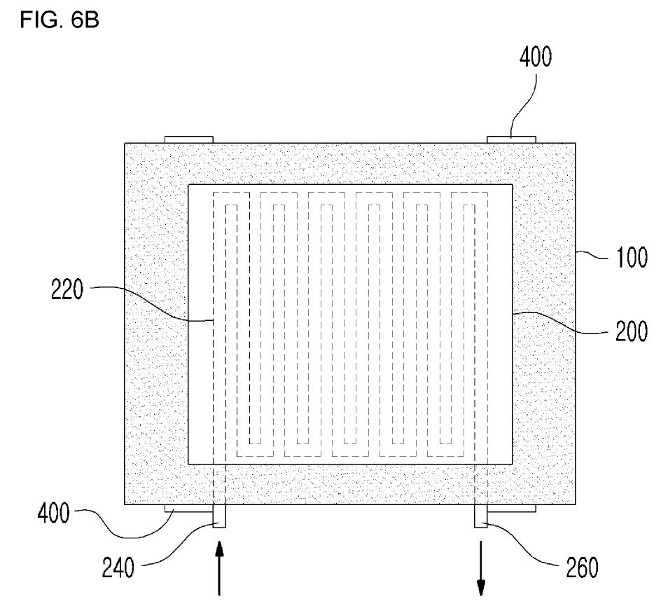

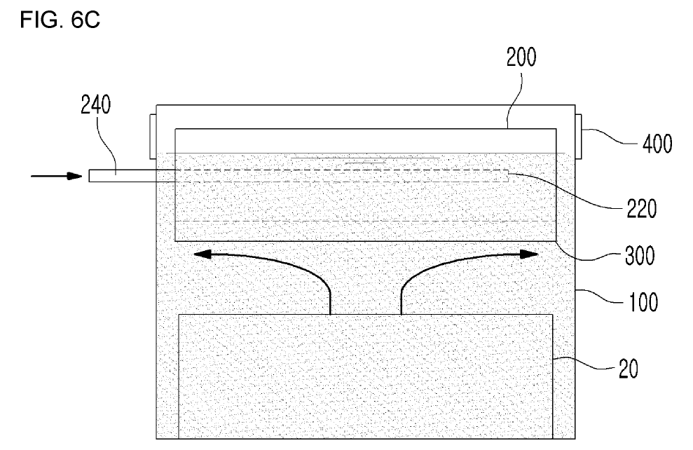

The cooling layer 200 according to an embodiment of the present disclosure mediates heat transfer between the immersion fluid 50 inside the case 100 and an external cooling medium (not shown in the figures). The cooling layer 200, in certain embodiments, includes a cooling channel 220 (such as FIGS. 4B and 6B) through which coolant can flow, and by allowing coolant to pass through, heat transferred from the immersion fluid 50 may be discharged to the outside.

As stated above, the cooling layer 200 according to an embodiment of the present disclosure includes a cooling channel 220 disposed in the cooling layer 200 through which a coolant flows. One or more coolant supply ports 240 connect, e.g., to a coolant supply unit (not shown) and installed on the cooling layer 200 may connect to the cooling channel 220 to provide coolant to the cooling layer 200, and one or more coolant recovery port 260 connected, e.g., to a coolant recovery unit (not shown), and installed on the cooling layer 200 may connect to the cooling channel 220 to remove coolant from cooling layer 200.

As illustrated in FIGS. 1 - 3, the cooling layer 200 is coupled to an upper portion of the case 100. Coolant supply port(s) 240 and coolant recovery port 260 induce the coolant to flow through the cooling layer in a vertical (FIG. 3) or horizontal dimension (FIGS. 1-2). cooling layer. The cooling layer 200, like the case, may also be formed of any suitable material, for example, a metallic (e.g., aluminum, copper) or a ceramic composite material having high thermal conductivity. In certain embodiments, the cooling layer is formed from aluminum, copper, and/or ceramic composite materials.

The cooling channel 220 (e.g., referring to FIGS. 4B and 6B) may be formed inside the cooling layer 200 and provide a path through which externally fed coolant is circulated inside the cooling layer 200 and then recovered. The cooling channel 220 may be a unidirectional or multi-directional channel and may include a main channel and optionally branch channels. The cross-sectional shape of the channels 220 is not particularly limited and may be, for example, circular, elliptical, polygonal, or any combination thereof (e.g., in different portions of the channel, e.g., to optimize heat transfer area and flow rate or flow velocity conditions).

The coolant supply port 240 may be coupled to the cooling layer 200 and to supply coolant from an external coolant reservoir or a pump unit. According to an embodiment, a flow rate sensor and/or a temperature sensor may be coupled to the coolant supply port 240 and/or coolant supply unit to which it is connected to monitor cooling performance and adjust cooling conditions if necessary.

A coolant recovery port may also be coupled to the cooling layer 200 and to recover coolant, which has absorbed heat from the heat transfer elements through walls of the cooling channel 220, to the outside of the apparatus. According to an embodiment, the coolant recovery port and/or coolant recovery unit to which it is connected may include one or more of a backflow prevention structure, a filter, a heat exchange unit, or the like, and the recovered coolant may be repeatedly used by recirculating the coolant back through the coolant supply port 240.

According to an embodiment, the coolant recovery port 260 may be disposed lower than the coolant supply port 240 to take advantage of the natural forces to induce fluid movement within the cooling layer. In certain embodiments, a coolant recovery port may be sloped or angled to avoid air retention or bubbles in the cooling channel 220.

In summary, a battery immersion cooling apparatus according to certain embodiments of the present disclosure, which includes a cooling layer, a cooling channel, a coolant supply port (and coolant supply unit), and a coolant recovery port (and coolant recovery unit) may effectively collect heat generated from the battery cells and transported through the immersion fluid 50 and into the cooling layer 200 to the outside. By including the cooling layer as described herein, supplemental cooling additional to the cooling achieved in an immersion cooling environment can be attained, thereby improving heat dispersion efficiency of the entire battery module.

The design and/or orientation of the cooling channel 220 within the cooling layer 200 is not particularly limited, and in certain embodiments may be oriented parallel to the length and width (i.e., broadest face or plane) the battery. Because the cooling channel is formed parallel to the broadest plane of the battery, heat exchange efficiency across the entire battery cell or module is improved. One of skill in the art will recognize various configurations that may be utilized to optimize heat transfer.

In the present disclosure, the cooling channel 220 is formed to pass through the inside of the cooling layer 200 so that heat exchange with the battery cell 10 or the battery module 20 is performed efficiently, and may be arranged to have a desired directionality and area, e.g., to dictate heat transfer. According to an embodiment, the cooling channel 220 may be connected to the cooling layer 200 such that the coolant is introduced from the coolant supply port 240, and the coolant having completed heat exchange is recovered through the coolant recovery port 260.

Such a cooling channel 220 may be arranged in various ways within the aforementioned parallel configuration, and in certain embodiments, may be formed by connecting a plurality of parallel channels.

As used herein, reference to a width dimension refers to the dimension corresponding to the shortest side of the battery cell 10, and reference to a length dimension refers to the dimension corresponding to the longest side of the battery cell 10.

In the present disclosure, since the cooling channel 220 is distributed on a plane parallel to the broadest surface (i.e., the length-width plane) of the battery cell 10, heat transfer between battery cells through the thermal transfer elements 300 may be more uniform .

In one embodiment, when the cells are stacked upright, a cooling channel 220 may be positioned to flow along an upper surface or a lower surface of each battery cell, thereby enhancing heat exchange with the thermal transfer element 300. For example, in the case of a pouch-type battery cell 10, a cooling channel 220 may be formed parallel to a long side dimension of the battery cell 10.

As described above, according to the embodiment of the present disclosure, since the cooling channel is in a parallel configuration (e.g., coolant flows in the channel in a dimension parallel to the length-width dimension of the apparatus), heat exchange efficiency in the entire battery cell or battery module may be increased.

The location of the coolant supply port and coolant recovery ports is not particularly limited. In certain embodiments, the coolant supply port 240 and the coolant recovery port 260 may be disposed parallel to each other with respect to the width dimension of the cooling layer 200 or a length dimension of the cooling layer 200.

The coolant supply port 240 is configured to supply coolant, e.g., from a coolant supply unit to the cooling channel 220 formed inside the cooling layer 200 and may be disposed at “an inlet side” of the cooling layer 200. The coolant recovery port 260 is configured to discharge or recovery the coolant, which has been circulated through the cooling channels 220 to effect heat exchange and after being introduced by the coolant supply port 240, to the outside of the apparatus. A coolant recovery port may be disposed at “an outlet side” of the cooling layer 200. The relative locations of the coolant supply port 240 and the coolant recovery port 260 determine a flow direction of the coolant within the cooling channel 220 and facilitate smooth circulation of the coolant inside the cooling layer 200.

In an embodiment, the coolant supply port 240 and the coolant recovery port 260 may be disposed parallel in the width dimension, such as shown in FIGS. 4A, 4B, 5, 6A and 6B) or the length dimension of the cooling layer 200, such as shown in FIGS. 1-3. Arrangement of the coolant supply port and coolant recovery port in the same length-width plane maintains a constant flow of the coolant and enables uniform distribution of the coolant throughout the cooling channel 220, thereby securing a balance of cooling efficiency.

In the embodiment wherein the coolant supply port and coolant recovery port are arranged oppositely in the length dimension (refer to FIGS. 1 and 2), the coolant supply port 240 and the coolant recovery port 260 are disposed at opposite sides of the cooling layer 200. Coolant is introduced from one side and discharged via the opposite side, or vice versa.

In embodiments wherein the coolant supply port and coolant recovery port are adjacently arranged in the width dimension, the coolant supply port 240 and the coolant recovery port 260 are formed on left and right sides of the cooling layer 200, respectively, and the coolant is introduced from the left and flows to the right, or vice versa. Flow direction may be selected as needed based on the configuration of the battery cell 10 or the battery module 20 within the cooling apparatus.

As described above, in embodiments wherein the coolant supply port and the coolant recovery port are disposed parallel to each other in the width-length plane, efficient heat exchange with the thermal transfer elements may be achieved throughout the cooling layer, thereby minimizing temperature deviation between cells and maintaining a thermal balance of the battery module.

In other embodiments, wherein coolant supply port and coolant recovery port are not installed in the same width-length plan, such as shown in FIG. 3, a plurality of coolant supply ports 240 may be disposed in a height dimension or “top” of the cooling layer 200. A coolant recovery port 260 is disposed such that flow through the coolant recovery port is substantially perpendicular to flow of the coolant through the coolant supply ports 260.

According to an embodiment, such as that shown in FIG. 3, coolant supply ports 240 may be provided in plurality to provide evenly distributed coolant within the cooling layer 200. As illustrated in FIG. 3, the coolant is evenly supplied to the cooling layer 200 by the plurality of coolant supply ports 240, and the coolant is recovered to the coolant recovery port 260.

As described above, by disposing the coolant supply port(s) and the coolant recovery port perpendicular to each other coolant may be uniformly distributed over the entire cooling layer, and local flow imbalance or a heat concentration phenomenon may be prevented.

Thermal transfer elements 300 may be formed on an internally facing side of the cooling layer 200 (i.e., the side intended to contact the immersion fluid 50) within the cooling apparatus. The thermal transfer elements are intended to increase the contact surface area between the cooling layer 200 and the immersion fluid 50 to increase a heat exchange with the immersion fluid 50. The thermal transfer elements 300 according to an embodiment are formed to protrude in an outward direction or an inward direction of the cooling layer 200 and may be entirely or partially in contact with the immersion fluid 50.

That is, the thermal transfer elements 300 are disposed in the warmer upper layer of the immersion fluid, formed by natural convective forces within the apparatus, so they may easily remove heat from this layer.

The thermal transfer elements 300 according to an embodiment of the present disclosure may be formed in any shape, for example may be shaped as a fin, a rib, a wave, a mesh, a honeycomb, a needle, or any combination thereof. Thermal transfer element 300 may all be the same single shape or may be formed by combining different shapes as necessary.

For example, a fin shape is formed as a protruding pillar shape having a predetermined length, and may be a cylinder or a polygonal prism shape. The fins may be arranged angled or straight with respect to the width-length plane of the apparatus , and may be evenly disposed or arranged in concentrated groups. A rib shape is a long plate-shaped protrusion, and may induce formation of a flow path through parallel or crossing arrangement, and control directionality of coolant flow. A wave shape is formed as a curved protrusion, and may increase heat transfer by inducing turbulent flow through a wavy surface.

A mesh shape is a structure in which a plurality of thin pins or thread-shaped structures are arranged to cross each other in a lattice or net shape, and can increase surface area. A honeycomb shape is formed in a hexagonal or regular polygonal cell structure, and can improve structural rigidity and heat transfer performance. A needle shape is a sharp-tipped, tapered structure designed to enhance heat exchange and reduce flow resistance. Depending on the immersion depth, the needle-shaped protrusion may be partially immersed, with a portion extending above the liquid level.

As described above, heat transfer elements of various shapes may be selectively employed to achieve an optimal heat transfer structure based on the cell’s position, heat generation characteristics, or a flow direction of the immersion fluid.

According to an embodiment of the present disclosure, the thermal transfer elements 300 may further be treated to impart a surface roughness (Ra) and further increase surface area and therefore heat transfer. Surface roughness also enhances turbulent flow in a boundary layer with the immersion fluid and increases a heat transfer coefficient.

For example, thermal transfer elements 300 may be formed with a surface roughness in a range of about 0.1μm to about 15μm. In preferred embodiments, the surface roughness is in a range of about 1μm to about 10μm, and more preferably in a range of about 3μm to about 7μm. As used herein, the term “about” refers to values within 10% of the named value.

The surface roughness (Ra) according to the embodiment is defined as an arithmetic average roughness value of a surface and is measured in micrometers (μm). Without wishing to be bound by theory, in embodiment when the surface roughness is less than 0.1μm, the effect of the roughness is insignificant. When surface roughness exceeds 15μm, fluid flow becomes more turbulent, as does flow resistance, which may lead to a decrease in cooling efficiency and a higher possibility of bubble formation. By roughening the surface of the thermal transfer elements within the aforementioned ranges, any bubbles that may have formed may detach, and wettability by the coolant may increase, thereby enhancing heat transfer.

According to an embodiment, thermal transfer elements 300 are formed as cylindrical fins, from an aluminum alloy-based metal material, and is processed to have a surface roughness of 5μm through sandblasting or anodizing (oxide film treatment). In alternative embodiments, the thermal transfer elements are provided as a needle-shaped thermal transfer elements 300 having a surface roughness of 5μm. The roughness forms fine irregularities on the surface to increase a contact area with the coolant, and induces turbulent flow in a boundary layer with the immersion fluid, thereby increasing a heat transfer coefficient.

As described above, the embodiment of the present disclosure includes the thermal transfer elements in direct contact with the immersion fluid to cool the battery cell or the battery module, thereby improving heat exchange performance between the cooling layer and the immersion fluid. Through this, thermal runaway of the battery may be suppressed, and discharge of high-temperature gas may be induced.

As stated herein, the thermal transfer elements may be variously shaped and may be incorporated into the cooling layer in a variety of manners. For example, FIG. 1 illustrates an embodiment of a cooling layer 200 in a battery immersion cooling apparatus according to an embodiment of the present disclosure, comprising inwardly-projecting thermal transfer elements 300 .

FIGS. 2 and 3 illustrate embodiments of cooling layers 200 in a battery immersion cooling apparatus according to certain embodiments of the present disclosure comprising outwardly-projecting thermal transfer elements 300.

As illustrated in FIGS. 4A-4C, the cooling layer structurally separated or detachable from the case 100 (“detachable cooling assembly”) to allow easier access to the cooling layer during cell replacement and maintenance of the immersion cooling apparatus. In FIGS. 4A-4C, and the thermal transfer elements 300 are depicted as fully immersed in the immersion fluid 50, thereby providing or defining a liquid headspace zone L. If necessary, the cooling layer may be selectively installed on an upper portion, a side portion, or a lower portion of the case 100.

According to an embodiment, the thermal transfer elements 300 are formed on one side of the detachable cooling layer 200 and may be immersed in the immersion fluid 50 inside the case 100. That is, it provides only the liquid headspace zone L. The thermal transfer element 300 immersed in the immersion fluid 50 is disposed at a position adjacent to an upper portion of the battery cell 10 or the battery module 20 and induces heat exchange with higher-temperature immersion fluid or gaseous fluid introduced along a heat rising path.

The liquid headspace zone L according to an embodiment of the present disclosure is a layer of immersion fluid 50 above the cells inside the case 100, spanning from the top of the immersion fluid 50 to a depth to where the thermal transfer element 300 are immersed. The presence of a liquid headspace zone L may not only increase the area for heat exchange but also provide a buffer space for temporary accumulation and transfer of gas or high-temperature fluid generated by the battery cells or modules.

Such a liquid headspace zone L may form a circulation flow path for the immersion fluid or be utilized as an upward discharge path for high-temperature gas, and may provide stable thermal management performance even under natural convection or external forced convection conditions when combined with the cooling layer 200 and the thermal transfer elements 300.

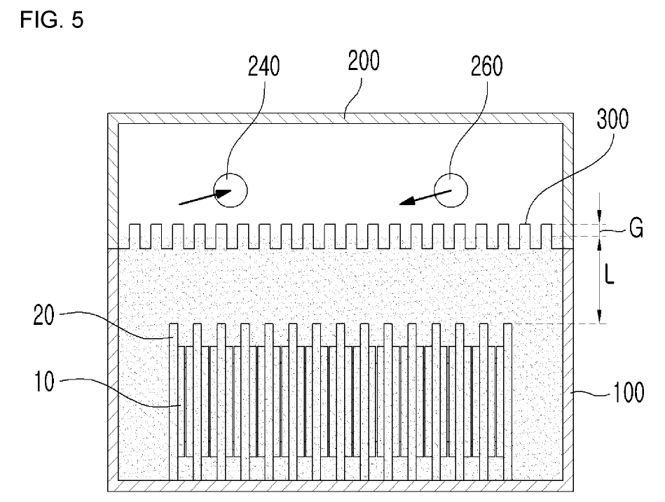

FIG. 5 is a schematic view illustrating a structure in which only a portion of the thermal transfer elements 300 are immersed, thereby forming a gas headspace zone G.

As illustrated in FIG. 5, according to an embodiment of the present disclosure, the thermal transfer elements 300 are only partially immersed in the immersion fluid 50, such that a lower portion of each thermal transfer element 300 is positioned in the liquid headspace zone L, and an upper portion of the thermal transfer element 300 is positioned in the a gas headspace zone G.

Although depicted in an embodiment having a detachable cooling assembly, thermal transfer elements 300 that are configured to be partially immersed may equally be provided even in a cooling apparatus having an integrated cooling assembly .

In embodiments wherein the cooling layer and immersion fluid are configured to provide both a liquid headspace zone and gas headspace zone, heat transfer is allowed to occur simultaneously in both the liquid phase and gas phase. Such a configuration allows the high-temperature gas to be discharged quickly while enabling heat exchange with the high-temperature gas through the thermal transfer elements 300. Furthermore, the gas headspace zone G reduces a linear velocity of the high-temperature gas to minimize splashing of immersion fluid, and heat exchange with the immersion fluid may be induced through the thermal transfer element 300.

In certain embodiments, fin-type thermal transfer elements 300are formed on an internally-facing side of the cooling layer 200. In certain embodiments, about 60% of the height of each thermal transfer element 300 is immersed in the liquid headspace zone L of the immersion fluid, and the remaining 40% of the thermal transfer element may be exposed in the gas headspace zone G.

The thermal transfer element 300 according to the embodiment of the present disclosure is disposed in the warmer upper layer of the immersion fluid, Fine bubbles generated at the gas-liquid interface can be easily detached due to turbulence around the thermal transfer elements 300 and an interface breaking effect. In this case, when a needle-shaped thermal transfer elements 300 are utilized, wettability of the thermal transfer elements is improved due to a capillary effect, and bubbles can be removed more efficiently.

This configuration allows the gas headspace zone G to be created simply by only adjusting the level of the immersion fluid. This arrangement enables removal of residual heat in the upper fluid layer and suppresses bubbles formation, making it advantageous for battery modules having a low C-rate and thus do not generate a high amount of heat.

As described above, according to the embodiment of the present disclosure, the cooling layer may installed separately from the case, and the thermal transfer elements may be partially immersed across the liquid headspace zone L and the gas headspace zone G, so that heat exchange with both the high-temperature gas and the immersion fluid may be performed. Accordingly, heat generated in the upper portion of the cell is efficiently removed through both the immersion fluid and the gas thereby forming a retention space and a discharge path for the high-temperature gas and liquid and preventing propagation of thermal runaway.

In one embodiment of the present disclosure, the cooling layer 200 is disposed inside the case 100, the thermal transfer elements 300are immersed in the immersion fluid, and a gas headspace zone G is formed between the cooling layer 200 and an inner wall of the case 100, thereby providing the cell upper gas space G and a cell upper liquid space L.

The battery immersion cooling apparatus according to the embodiment of the present disclosure disposes the cooling layer 200 inside the case 100 accommodating the immersion fluid, thereby providing a more direct and closer heat exchange path compared to a case where a cooling structure is installed outside of the case 100.

The cooling layer 200 is disposed inside where the battery cell 10 or the battery module 20 is accommodated in an immersed state and may be fixed to one surface or a plurality of surfaces inside the case 100 or installed via a support. In this configuration, all or a part of the cooling layer 200 is disposed at a position spaced apart from the inner wall of the case 100, thereby forming a gas space. The thermal transfer elements 300 are formed on an internally facing side of the cooling layer 200, and the thermal transfer elements 300 may be disposed immersed in the immersion fluid 50.

In the space between the cooling layer 200 and the inner wall of the case 100 according to an embodiment, gas headspace zone G, where high-temperature gas generated from the battery cell or battery module can accumulate is formed. At the same time, since the thermal transfer elements 300 are immersed in the immersion fluid, a liquid headspace zone L is also provided. Therefore, since the gas headspace zone G and a liquid headspace zone L are formed simultaneously, heat generated from the cell is efficiently removed, and retention and discharge of high-temperature gas are induced, thereby preventing propagation of thermal runaway.

The gas headspace zone G, according to an embodiment of the present disclosure, maybe in fluid communication with a gas discharge unit 400 formed on one side of the case 100, so that gas generated during a runaway reaction can be discharged.

The gas headspace zone G is a space formed above the battery cell 10, above the surface of the immersion fluid. This gas headspace zone G may act as a retention space where high-temperature gas formed during heat generation or a runaway reaction of the cell temporarily accumulates. The temporarily accumulated high-temperature gas may then be discharged to the outside through the gas discharge unit 400 in fluid communication with the gas headspace zone G.

As described above, according to the embodiment of the present disclosure, since the gas headspace zone G is in fluid communication with the gas discharge unit, the high-temperature gas generated during the runaway reaction is quickly discharged to the outside, and pressure rise inside the battery system can be prevented.

Also, by reducing thermal energy of the high-temperature gas through contact with the thermal transfer element before gas discharge, the temperature of the discharged gas can be reduced, thereby minimizing a possibility of a secondary explosion.

As illustrated in FIGS. 7A - 7C and FIG. 8A -8C, the cooling layer according to an embodiment of the present disclosure may include a coolant supply port 240 disposed at an upper portion, and an impingement jet array disposed below the coolant supply port 240 to spray coolant toward the thermal transfer elements.

The impingement jet array according to an embodiment of the present disclosure is installed below the coolant supply port 240, so that the coolant may be sprayed toward the thermal transfer element. In an embodiment of the present disclosure, the impingement jet array is implemented through a spray nozzle, and the coolant may be sprayed vertically or obliquely toward the thermal transfer element.

FIG. 7A is a schematic front view illustrating a detachable cooling assembly cooling layer having an impingement jet arrays in the battery immersion cooling apparatus according to an embodiment of the present disclosure. FIG. 7B is a schematic plan view illustrating a detachable cooling assembly cooling layer having an impingement jet arrays in the battery immersion cooling apparatus according to an embodiment of the present disclosure. FIG. 7C is a schematic side view illustrating a detachable cooling assembly cooling layer having an impingement jet arrays in the battery immersion cooling apparatus according to an embodiment of the present disclosure.

As illustrated in FIGS. 7A- 7C, the impingement array may include a coolant supply manifold 282 connected to the coolant supply port 240, and a plurality of impingement nozzles 284 connected to the coolant supply manifold 282 and arranged in a width dimension of the cooling layer 200.

The impingement jet array is connected to the coolant supply port 240 and may spray the coolant supplied from the coolant supply port 240 at high speed to improve heat exchange efficiency with the thermal transfer element.

The coolant supply manifold 282 according to an embodiment is connected to the coolant supply port 240 to receive the coolant and provides uniform flow distribution to the impingement nozzles 284. The coolant supply manifold 282 efficiently distributes coolant to the plurality of nozzles while maintaining pressure of the coolant. An inlet connected to the coolant supply port 240 is formed on one side, and outlets respectively connected to the plurality of impingement nozzles 284 are formed on another side.

The impingement nozzles 284 according to an embodiment are connected between the coolant supply manifold 282 and coolant receiver (the rectangle indicated by a dotted line below the impingement nozzles 284 in FIG. 7A) and are arranged at predetermined intervals along the width dimension of the cooling layer 200. Each nozzle sprays the coolant at high speed in a downward or inclined direction to increase a heat transfer speed between the thermal transfer element and the coolant. The coolant sprayed from the impingement nozzles (284) can be discharged to the coolant recovery unit (260) through the coolant receiver. During the coolant stays or moves in the coolant receiver, heat transfer can occur between the thermal transfer element located below the coolant receiver and the coolant contained in the coolant receiver.

FIG. 8A is a schematic front view illustrating a detachable cooling assembly comprising a cooling layer 200 having an impingement jet array for use in a battery immersion cooling apparatus according to an embodiment of the present disclosure. FIG. 8B is a schematic plan view illustrating a detachable cooling assembly comprising a cooling layer having an impingement jet array for use in a battery immersion cooling apparatus according to an embodiment of the present disclosure. FIG. 8C is a schematic side view illustrating a detachable cooling assembly comprising a cooling layer having an impingement jet array for use in a battery immersion cooling apparatus according to an embodiment of the present disclosure.

As illustrated in FIGS. 8A - 8C, the impingement jet array may include a coolant supply manifold 282 connected to the coolant supply port 240 and disposed at a center of the cooling layer 200 in a length dimension, and a plurality of impingement nozzles 284 connected to the coolant supply manifold 282 and branching to both sides from the coolant supply manifold 282.

The coolant supply manifold 282 according to an embodiment is disposed at the center of the cooling layer 200 in the length dimension, receives the coolant from the coolant supply port 240, and distributes the coolant to the plurality of impingement nozzles 284.

The plurality of impingement nozzles 284 are coupled to the coolant supply manifold 282, and may spray the coolant supplied from the manifold at high speed in a downward or diagonal direction. According to an embodiment, the impingement nozzles 284 are arranged symmetrically along a width dimension of the cooling layer 200, and may have the same diameter and angle, or may be formed in an asymmetric shape according to a thermal load distribution.

As described above, the impingement jet array according to the embodiment of the present disclosure sprays the coolant onto the thermal transfer element of the cooling layer, thereby improving cooling performance in a local heat concentration region that is difficult for the immersion fluid to reach.

According to an embodiment of the present disclosure, the cooling layer 200 may include a coolant recovery port 260 disposed below the impingement nozzles 284 and configured to collect the sprayed coolant.

The coolant recovery port 260 according to an embodiment is disposed below the impingement nozzles 284, and the coolant sprayed at high speed from the impingement nozzles 284 may be transferred to the outside or a circulation system through the coolant recovery port 260.

The cooling layer according to an embodiment of the present disclosure may be formed of a plurality of module units, and may provide thermal transfer elements having different shapes or different arrangements for each module.

The plurality of cooling layer modules may each include thermal transfer elements of different shapes or different arrangements. For example, different protrusion shapes (e.g., a fin type for a first module, a rib type for a second module, and a needle type for a third module) may be applied for each module, or protrusions of the same shape may be applied but with different arrangement directions or densities (e.g., linear arrangement, diagonal arrangement, cross arrangement, etc.). These may be appropriately combined according to a usage environment, a cell position, a cooling demand, etc.

Through this, effects such as mitigation of local heat concentration in an immersion cooling environment, heat dispersion during a runaway reaction, and improvement of cell lifespan may be obtained, and it may be applied to various battery pack environments.

At least one gas discharge unit 400 configured to discharge gas generated during a battery thermal runaway reaction to the outside may be formed on one side of the case 100 according to an embodiment of the present disclosure. This is to prevent damage to the case 100 and propagation of thermal runaway due to an internal pressure rise, and to safely discharge high-temperature gas to the outside.

The gas discharge unit 400 may include one or more of a valve structure, a filter structure, or a one-way discharge structure. For example, a gas discharge unit may include a structure such as a rupture disk (or burst disk), a safety valve, a filter structure, and/or a differential pressure operated opening, and a plurality of gas discharge units 400 may be formed at specific positions of the case 100 as necessary.

The gas discharge unit 400 according to an embodiment may be configured to be heat and pressure resistant, considering that gas generally generated during a battery runaway reaction has a high temperature of about 700° C to 1100° C and a pressure condition of several hundred kPa or more. For example, a rupture disk made of an aluminum alloy is designed to automatically open at a set pressure of 300kPa, and a heat-resistant silicone gasket is inserted into an outer periphery of the disk to maintain sealing with the case 100.

According to an embodiment, the gas discharge unit 400 is in fluid communication with the gas headspace zone G, so that gas generated during the runaway reaction can be quickly discharged.

According to an embodiment, the gas discharge unit 400 may be positioned on one side of an upper portion of the case 100, for example, above the cooling layer 200 on which the thermal transfer elements 300 are formed.

Also, a plurality of gas discharge units 400 may be distributed and disposed in different directions, and even when any one gas discharge unit 400 is inoperable, a remaining discharge path can be secured.

In some embodiments, a thermally activatable opening/closing cap is installed on an opening of the gas discharge unit 400 to be automatically opened under a temperature condition of 180°C or higher, thereby enabling an initial response in the event of a battery fire or thermal runaway.

As described above, according to the embodiment of the present disclosure, when a runaway reaction occurs in a battery cell or a battery module, high-temperature and high-pressure gas inside the inner case is quickly and safely discharged to the outside, thereby preventing rupture of the case or heat transfer to adjacent cells, and blocking propagation of thermal runaway within the entire system.

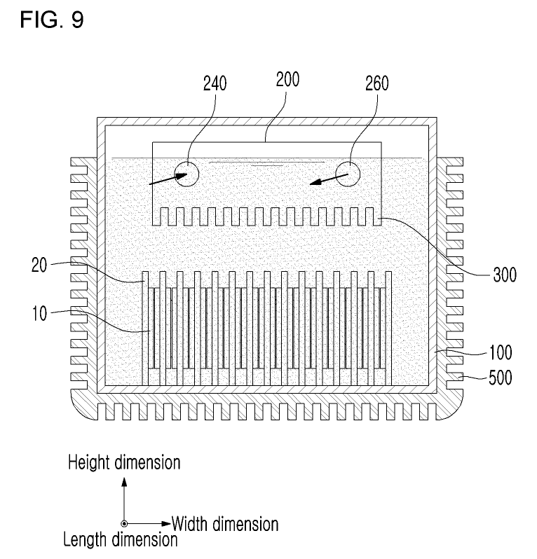

FIG. 9 is a schematic view illustrating heat sink fins formed on the outer surface of the case of the battery immersion cooling apparatus according to an embodiment of the present disclosure.

As illustrated, the outer surface of the case 100 may be formed comprising a plurality of heat sink fins 500.

The heat sink fins 500 according to an embodiment of the present disclosure may be formed from a metallic material and configured in a shape to protrude from the outer surface of the case 100. The plurality of heat sink fins 500 are arranged at predetermined intervals to increase contact area with air and promote heat dissipation by natural convection.

The heat sink fins 500 according to the embodiment may be uniformly distributed on the entire outer wall of the case 100, or may be locally disposed in a specific high-heat region (e.g., an upper portion of the coolant recovery port 260, a vicinity of the coolant supply port 240, etc.).

According to an embodiment, the cross-sectional shape of the heat sink fins 500 may be varied and may be, for example, rectangular, circular, rib-type, or wing-type shape. The material is likewise not limited, and may be an aluminum alloy, a copper (Cu) alloy, stainless steel, or the like. One of skill in the art will recognize various materials having high thermal conductivity that may be used.

As described above, the heat sink fins on the outer surface of the case according to the embodiment of the present disclosure provides an additional heat dissipation path on the outer surface of the case in addition to cooling by the immersion fluid and the cooling layer, thereby improving heat dissipation capability of the entire battery immersion cooling apparatus and preventing propagation of thermal runaway.

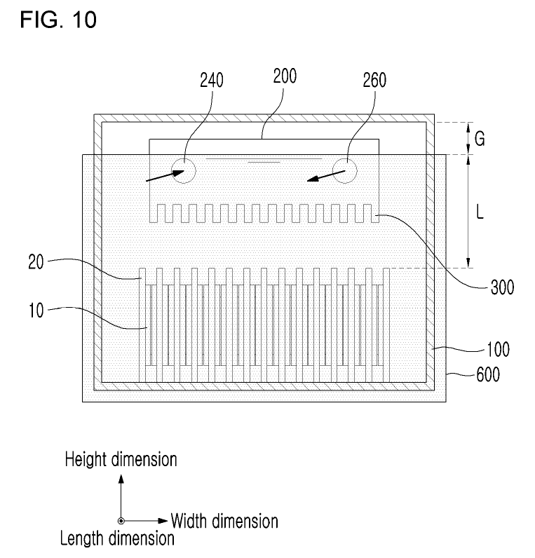

FIG. 10 is a schematic view illustrating a thermal jacket formed on an outer periphery of a case of a battery immersion cooling apparatus according to an embodiment of the present disclosure.

The thermal jacket 600 includes a plurality of covers and internal flow paths installed to be in close contact with the outer periphery of the case 100. Coolant may circulate through flow paths within the thermal jacket. In this configuration, the coolant is supplied from an external coolant supply port, absorbs heat from the battery or modules therein, and may then be recovered to an external coolant recovery port 260. The thermal jacket 600 may surround the entire case 100 or may be limitedly installed only on some high-temperature parts.

The thermal jacket 600 according to an embodiment may be formed of any material, such as a metallic material having high thermal conductivity, such as aluminum or copper.

According to an embodiment, the thermal jacket 600 and the case 100 are secured together by a thermally conductive adhesive or fixing bolts, and a sealing rubber for preventing fluid leakage may be attached to an edge thereof.

As described above, the thermal jacket on the outer periphery of the case according to the embodiment of the present disclosure adds an external cooling structure that operates independently of immersion cooling, thereby improving cooling performance of the entire battery immersion cooling apparatus and preventing of thermal runaway propagation.

According to the embodiment of the present disclosure, by immersing a battery cell or a module in an immersion fluid and enabling heat exchange with an upper portion of the cell through a cooling layer, overheating of the battery cell or the battery module may be prevented, and propagation of thermal runaway may be prevented.

According to the embodiment of the present disclosure, the thermal transfer elements contact the immersion fluid to improve heat transfer performance of the cooling layer, thereby suppressing thermal runaway of the battery and inducing discharge of high-temperature gas.

As described above, the present disclosure may contribute to securing thermal stability of ESS and electric vehicle battery systems through improvement of heat transfer performance, induction of high-temperature gas discharge, and activation of natural convection.

The contents described above are merely examples applying the principles of the present disclosure, and other configurations may be further included without departing from the scope of the present disclosure. For example, at least some of the various embodiments of the present disclosure described above may be combined.

What is claimed is:

1. A battery immersion cooling apparatus comprising:
a case configured to accommodate an immersion fluid and a battery cell, or a battery module immersed in the immersion fluid;
a cooling layer arranged at least one surface of the case; and
one or more thermal transfer elements formed on one side of the cooling layer and configured to exchange heat with the immersion fluid.

2. The apparatus of claim 1, wherein the cooling layer is detachable from the case, and the thermal transfer elements are configured to be fully immersed in the immersion fluid to provide a liquid headspace zone.

3. The apparatus of claim 1, wherein the cooling layer is disposed inside the case, the thermal transfer elements are configured to be partially immersed in the immersion fluid, and a gas headspace zone is formed between the cooling layer and an inner wall of the case.

4. The apparatus of claim 1, wherein the thermal transfer elements are partially immersed in the immersion fluid, a lower portion of each thermal transfer element is positioned in a liquid headspace zone, and an upper portion of the thermal transfer element is positioned in a gas headspace zone.

5. The apparatus of claim 3, wherein the gas headspace zone is in fluid communication with a gas discharge unit disposed on one side of the case and configured to discharge gas generated within the case.

6. The apparatus of claim 1, wherein the cooling layer comprises a cooling channel through which a coolant flows , a coolant supply port, and a coolant recovery port.

7. The apparatus of claim 6, wherein the cooling channel is configured such that coolant therein flows in a direction parallel to a width-length plane of the battery.

8. The apparatus of claim 6, wherein the coolant supply port and the coolant recovery port are disposed parallel to each other in a width dimension of the cooling layer or a length dimension of the cooling layer.

9. The apparatus of claim 6, wherein the coolant supply port is disposed in a height dimension of the cooling layer, and the coolant recovery port is disposed in a width dimension or a length dimension of the cooling layer, wherein the coolant supply port and the coolant recovery port are disposed such that coolant flow through the coolant supply port is perpendicular to that through the coolant recovery port.

10. The apparatus of claim 9, comprising a plurality of coolant supply ports distributed along a width or length dimension of the cooling layer.

11. The apparatus of claim 1, wherein the cooling layer comprises: a coolant supply port disposed at an upper portion of the cooling layer; and an impingement jet array disposed below the coolant supply port and configured to spray coolant toward the thermal transfer elements.

12. The apparatus of claim 11, wherein the impingement jet array comprises a coolant supply manifold connected to the coolant supply port; and a plurality of impingement nozzles connected to the coolant supply manifold and arranged in a width dimension of the cooling layer.

13. The apparatus of claim 11, wherein the impingement jet array comprises: a coolant supply manifold connected to the coolant supply port and disposed at a center of the cooling layer in a length dimension; and a plurality of impingement nozzles connected to the coolant supply manifold and branching to both sides from the coolant supply manifold.

14. The apparatus of claim 13, wherein the cooling layer comprises a coolant recovery port disposed below the impingement nozzles and configured to collect the sprayed coolant.

15. The apparatus of claim 1, wherein the cooling layer comprises a plurality of module units, and provides thermal transfer elements having different shapes or different arrangements for each module.

16. The apparatus of claim 1, wherein the thermal transfer elements have a shape of at least one of a fin, a rib, a wave, a mesh, a honeycomb, and a needle.

17. The apparatus of claim 1, wherein the thermal transfer elements have a surface roughness (Ra) in a range of 0.1μm to 15μm.

18. The apparatus of claim 1, wherein at least one gas discharge unit is disposed on one side of the case and configured to discharge gas generated during a battery thermal runaway reaction to the outside.

19. The apparatus of claim 1, wherein an outer surface of the case comprises heat sink fins.

20. The apparatus of claim 1, further comprising a thermal jacket disposed on an outer periphery of the case.
